(19) United States
(12) Patent Application Publication
(10) Pub. No.: US 2026/0149337 A1
(43) Pub. Date: May 28, 2026

(54) PIEZOELECTRIC MEASURING DEVICE FOR MOTOR VEHICLE

(71) Applicant: Continental Automotive Technologies GmbH, Hannover (DE)

(72) Inventors: Thomas MORIN, Toulouse (FR); Eric SENECHAL, Cugnaux (FR); Franck NIECERON, Toulouse (FR)

(73) Assignee: Continental Automotive Technologies GmbH, Hannover (DE)

(21) Appl. No.: 19/351,679

(22) Filed: Oct. 7, 2025

(30) Foreign Application Priority Data
Nov. 22, 2024 (FR) FR2412833

(51) Int. Cl. H02K 11/25; G01K 1/024; H01M 10/48; H02K 7/00; H02K 11/00; H04B 11/00

(52) U.S. Cl. CPC H02K 11/25; G01K 1/024; H01M 10/486; H02K 7/006; H02K 11/0094; H04B 11/00; H01M 2220/20

(57) ABSTRACT

A device for measuring a parameter, including a main module and a remote module. The main module includes a control stage and a piezoelectric transmitter that is configured to transmit ultrasonic signals. The control stage being configured to electrically power the piezoelectric transmitter and to command transmission of signals by the piezoelectric transmitter. The remote module includes a piezoelectric receiver, a sensitive element configured to measure the parameter and to generate a measurement signal, and a measurement stage configured to collect and store the energy of the signals received by the piezoelectric receiver with a view to electrically powering the sensitive element, to receiving a measurement signal generated by the sensitive element, to extracting from said received measurement signal the values of the measured parameter and to commanding transmission of signals containing the extracted parameter values.

### CROSS REFERENCE TO RELATED APPLICATION

This application claims priority to French Application No. 2412833, filed Nov. 22, 2024, the contents of such application being incorporated by reference herein.

### FIELD OF THE INVENTION

The present invention relates to the automotive field, and more particularly to a piezoelectric measuring device for a motor vehicle and to a method for implementing same.

### BACKGROUND OF THE INVENTION

As known, an electric motor comprises a rotor and a stator. Operation of such a motor causes heating of the rotor and stator. However, the rise in temperature of the rotor may cause a loss of performance and demagnetization of the magnets placed inside above a certain temperature, this potentially leading to damage or even failure of the motor. It is therefore necessary to measure the temperature inside the rotor, so as to be able to reduce the speed thereof as its temperature approaches the critical operating limit and thus avoid damage to or failure of the motor.

Because of its rotation during its operation, the temperature of the rotor is difficult to measure directly using wired temperature sensors, and it is therefore estimated via algorithms and models integrated into the control system of the motor.

However, these integrated algorithms and models sometimes make measurement errors of plus or minus 20° C., this being unsatisfactory in the context of controlling the motor to avoid damaging it or its failure.

A simple, reliable and efficient solution allowing these drawbacks to be at least partly overcome would therefore be advantageous.

### SUMMARY OF THE INVENTION

To this end, a first aspect of the invention is a device for measuring a parameter in a motor vehicle, said device comprising a main module and a remote module, said main module comprising a control stage and a piezoelectric transmitter that is configured to transmit ultrasonic signals, said control stage being configured to electrically power said piezoelectric transmitter and to command transmission of signals by said piezoelectric transmitter, said remote module comprising a piezoelectric receiver configured to receive ultrasonic signals transmitted by the piezoelectric transmitter, a sensitive element configured to measure said parameter and to generate a measurement signal containing at least one value of said parameter, and a measurement stage that is connected on the one hand to the piezoelectric receiver and on the other hand to said sensitive element, and that is configured to collect and store the energy of the signals received by the piezoelectric receiver with a view to electrically powering the sensitive element, to receiving a measurement signal generated by the sensitive element, to extracting from said received measurement signal the values of the measured parameter and to commanding transmission of signals containing the extracted parameter values.

The device according to an aspect of the invention allows remote measurements to be taken via the remote module, by powering the sensitive measuring element with the energy of signals sent by the main module over a wireless link. Thus, the measurements may be taken as close as possible to the magnets, this increasing the performance of the control of the electric machine. An aspect of the invention further makes it possible to dispense with metal barriers such as, for example, a casing or protective flanges, which may at least partly block electromagnetic waves such as those used for Wi-Fi or Bluetooth.

In one embodiment, the piezoelectric receiver of the remote module also being a piezoelectric transmitter and the piezoelectric transmitter of the main module also being a piezoelectric receiver, the measurement stage is configured to command transmission of signals containing the measured values via said piezoelectric transceiver of the remote module and the control stage of the main module is configured to receive the signals containing the measured values via said piezoelectric transceiver of the main module.

Alternatively or in addition, the remote module comprising an external communication stage, the measurement stage may be configured to command transmission of signals containing the measured values via said external communication stage. The measured values can thus be sent to an entity outside the measurement device for processing.

The external communication stage may for example transmit using a Bluetooth, Wi-Fi, 5G or RFID communication protocol.

In one embodiment, the piezoelectric transmitter of the main module is configured to resonate at least at one predetermined frequency, the control stage is configured to generate a signal at said at least one predetermined frequency and to deliver the generated signal to the piezoelectric transmitter of the main module, and the piezoelectric receiver of the remote module is configured to resonate at said at least one predetermined frequency. These technical features enable selectivity in communication and in particular allow a plurality of remote modules to be used with a single main module, this improving performance and making it possible to adjust frequency depending on the normal modes of the electric machine and on acoustic reflections.

An aspect of the invention also relates to an electric machine for a motor vehicle, said electric machine comprising a stator, a rotor and a measuring device as described above, said electric machine being configured to be mounted in said vehicle in order to drive the wheels of said vehicle to rotate, in which electric machine the stator comprises the main module and the rotor comprises the remote module.

Preferably, the main module is mounted on and/or in the stator and the remote module is mounted on and/or in the rotor.

In one embodiment, the rotor comprises a hollow drum, equipped in its internal space with magnetic elements, and a shaft, and the sensitive element is mounted inside said drum.

In one embodiment, the rotor comprising a shaft comprising a first shaft portion and a second shaft portion that are mounted on the stator via a system of bearings, the first shaft portion having an end face extending orthogonally to the longitudinal axis of rotation of the rotor, the piezoelectric receiver of the remote module is mounted on said end face or integrated into a cavity of the rotor, the piezoelectric transmitter of the main module possibly being mounted anywhere on the stator, and for example on a portion of the stator facing said piezoelectric receiver.

In another embodiment, the rotor comprising a drum mounted on a shaft, the piezoelectric transceiver of the remote module is mounted on the stator facing said shaft, for example at less than 50 cm therefrom, and the sensitive element is mounted inside said drum, the acoustic signals then passing from the piezoelectric transceiver to the shaft, then through the shaft, then into the drum to reach the sensitive element and vice versa.

In another embodiment, the rotor comprising a drum and a hollow shaft, which passes through the drum and which is filled with a coolant, oil for example, the piezoelectric transceiver of the remote module is mounted inside said shaft, in the cooling liquid, and the sensitive element is mounted inside said drum.

An aspect of the invention also relates to a motor-vehicle battery comprising a measuring device as described above, the remote module being mounted such that the sensitive element is placed in said battery.

An aspect of the invention also concerns a motor-vehicle battery pack comprising a measuring device as described above, comprising at least one remote module mounted such that the sensitive element is placed in at least one of the batteries of the battery pack.

An aspect of the invention also concerns a motor-vehicle fuel cell comprising a measuring device as described above, the remote module being mounted such that the sensitive element is placed in said fuel cell.

An aspect of the invention also relates to a motor vehicle comprising a measuring device as described above.

In one embodiment, the vehicle is an electric or hybrid electric vehicle and comprises an electric machine as described above.

In one embodiment, the vehicle comprises a battery or a battery pack or a fuel cell as described above.

An aspect of the invention also concerns a method for measuring a parameter in a motor vehicle using a measuring device as described above, said method comprising the steps of:
commanding, by means of the control stage of the main module, transmission of ultrasonic signals by the piezoelectric transmitter of the main module,
transmitting, by means of the piezoelectric transmitter of the main module, said ultrasonic signals,
receiving, by means of the piezoelectric receiver of the remote module, the transmitted signals,
collecting and storing, by means of the measurement stage of the remote module, energy of the received signals,
electrically powering, by means of the measurement stage, using the stored energy, the sensitive element of the remote module,
measuring, by means of the sensitive element, said parameter and generating a measurement signal,
transmitting, by means of the sensitive element, said generated measurement signal to the measurement stage,
receiving, by means of the measurement stage, the measurement signal,
extracting, by means of the measurement stage, the values of the measured parameter contained in the received measurement signal,
commanding, by means of the measurement stage, transmission of signals comprising the extracted parameter values.

Preferably, the energy of the received signals is stored, by means of the measurement stage, until a predetermined threshold is reached, and then the sensitive element is electrically powered using the stored energy.

### BRIEF DESCRIPTION OF THE DRAWINGS

Other features and advantages of aspects of the invention will become more apparent upon reading the following description. It is purely illustrative and should be read with reference to the appended drawings, in which:

FIG. 1 schematically illustrates, in a functional manner, a first embodiment of the measuring device according to an aspect of the invention.

FIG. 2 schematically illustrates, in a functional manner, a second embodiment of the measuring device according to an aspect of the invention.

FIG. 3 schematically illustrates one example of an electric machine according to an aspect of the invention.

FIG. 4 schematically illustrates one example of a battery according to an aspect of the invention.

FIG. 5 schematically illustrates one example of a battery pack according to an aspect of the invention.

FIG. 6 schematically illustrates one example of a fuel cell according to an aspect of the invention.

FIG. 7 schematically illustrates one embodiment of the method according to an aspect of the invention.

### DESCRIPTION OF EMBODIMENTS

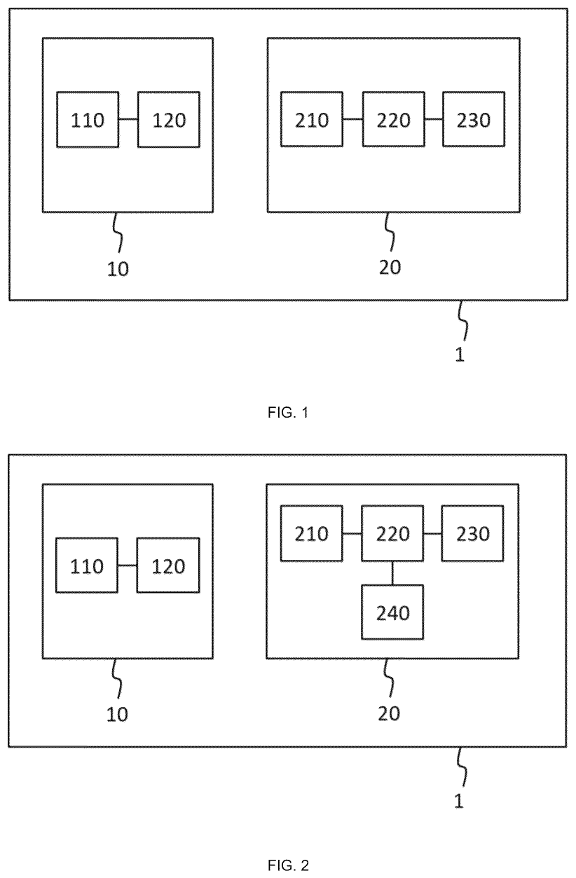

FIG. 1 is one example of a measuring device 1 according to an aspect of the invention. The device 1 is intended to be mounted in a motor vehicle.

The device 1 comprises a main module 10 and a remote module 20.

### Main Module 10

The main module 10 comprises a control stage 110 and a piezoelectric transmitter 120.

The control stage 110 is configured to electrically power said piezoelectric transmitter and to command transmission of ultrasonic signals by said piezoelectric transmitter.

The piezoelectric transmitter 120 is configured to transmit ultrasonic signals, when it is commanded to do so by the control stage.

### Remote Module 20

The remote module 20 comprises a piezoelectric receiver 210, a measurement stage 220 and a sensitive element 230.

The piezoelectric receiver 210 is configured to receive ultrasonic signals transmitted by the piezoelectric transmitter 120.

The measurement stage 220 is electrically connected on the one hand to the piezoelectric receiver 210 and on the other hand to the sensitive element 230.

The measurement stage 220 is configured to collect and store energy of the ultrasonic signals transmitted by the piezoelectric transmitter 120 and received by the piezoelectric receiver 210.

The measurement stage 220 is configured to power the sensitive element 230 electrically.

The measurement stage 220 is configured to receive a measurement signal S generated by the sensitive element 230 during a measurement or a series of measurements.

The measurement stage 220 is configured to extract the measured values from the received measurement signal S.

The measurement stage 220 is configured to command transmission of signals comprising the measured values.

The sensitive element 230 is configured to be electrically powered by the measurement stage 220.

The sensitive element 230 is configured to measure said parameter.

The sensitive element 230 is configured to generate a measurement signal S comprising the one or more values of the measured parameter and to transmit said signal.

The sensitive element 230 is configured to transmit the generated measurement signal S to the measurement stage 220.

In one embodiment, the piezoelectric receiver 210 of the remote module 20 also being a piezoelectric transmitter (transceiver) and the piezoelectric transmitter 120 of the main module 10 also being a piezoelectric receiver (transceiver), the measurement stage 220 is configured to command transmission of ultrasonic signals including the measured values (extracted from the measurement signal S) via the piezoelectric transceiver 210 of the remote module 20 and the control stage 110 of the main module 10 is configured to receive the signals containing the measured values via said piezoelectric transceiver 120 of the main module 10.

In another embodiment, illustrated in FIG. 2, the remote module 20 comprising an external communication stage 240, the measurement stage 220 is configured to command the transmission of signals containing the measured parameter values (extracted from the measurement signal S) via said external communication stage 240. This transmission may for example be carried out over a Bluetooth or RFID communication interface, known per se. In this case, the external communication stage 240 preferably comprises a microcontroller allowing this transmission function to be performed.

In one embodiment:
the piezoelectric transmitter 120 of the main module 10 is configured to resonate at least at one predetermined frequency, and preferably at two predetermined frequencies, 200 kHz and 2 MHz for example,
the control stage 110 is configured to generate a signal at said at least one predetermined frequency and to deliver the generated signal to the piezoelectric transmitter 120 of the main module 10, and
the piezoelectric receiver 210 of the remote module 20 is configured to resonate at said at least one predetermined frequency.

Preferably, the measurement stage 220 is configured to electrically power the sensitive element 230 using the stored energy only when a predetermined energy storage threshold has been reached.

The remote module 20 may comprise more than one sensitive element, with a view to measuring a plurality of parameters.

The measured parameter(s) may be, for example, air temperature, air pressure, moisture content, electric current, mechanical force (stress), torque, etc.

### Examples of Use of the Measuring Device According to an Aspect of the Invention

### Example 1: Electric Machine 300

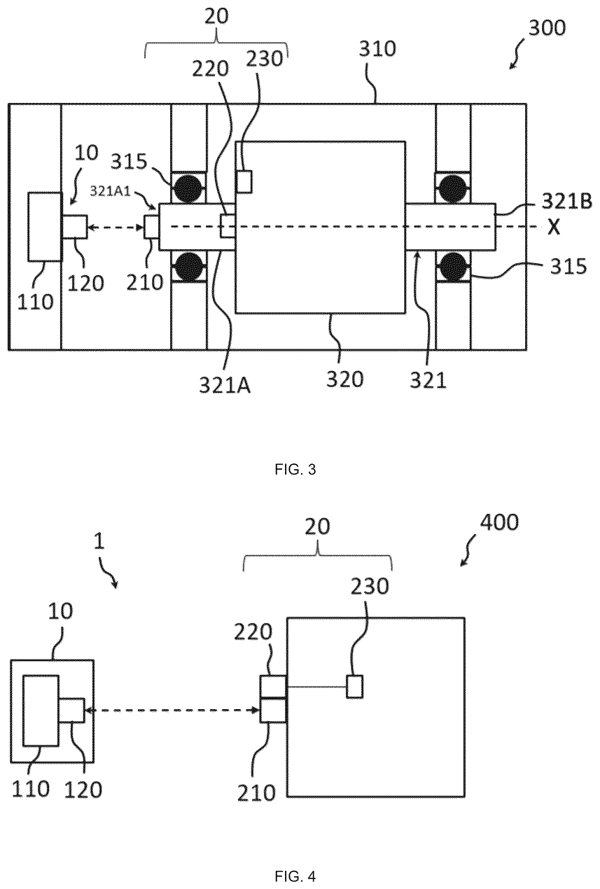

FIG. 3 is an example of an electric machine 300 for a motor vehicle. The electric machine 300 is configured to be mounted in the vehicle in order to set into rotation the wheels of said vehicle.

The electric machine 300 comprises a stator 310, a rotor 320, and a device 1 as described above.

The main module 10 is mounted on the stator 310 and the remote module 20 is mounted on the rotor 320.

The rotor 320 is configured to rotate about a longitudinal axis X.

In this example, the rotor 320 comprises an integral shaft 321 extending along the longitudinal axis X of rotation and containing a first shaft portion 321A and a second shaft portion 321B which are connected to the stator 310 via a system of bearings 315.

The first shaft portion 321A comprises an end face 321A1 extending orthogonally to the longitudinal axis X of rotation of the rotor 320. The piezoelectric receiver 210 of the remote module 20 is mounted on said end face 321A1 and the piezoelectric transmitter 120 of the main module 10 is mounted on a portion of the stator 310 facing said piezoelectric receiver 21.

### Example 2: Battery 400

FIG. 4 is an example of a battery 400 for a motor vehicle.

The main module 10 is placed away from the battery 400 while the remote module 20 is mounted on the battery 400 such that the sensitive element 230 measures a parameter inside said battery 400, for example temperature or pressure, moisture content, electric current, mechanical force (stress), torque, etc.

It will be noted that the remote piezoelectric transceiver 210 and the measurement stage 220 may be mounted on an external face of the battery 400 or inside the battery 400 with the sensitive element 230, as in example 1 of an electric machine.

### Example 3: Battery Pack 500

FIG. 5 is an example of a battery pack 500 for a motor vehicle.

The main module 10 is placed away from the battery pack 500 while one or more respective remote modules 20 are mounted on one or more of the batteries 400 of the battery pack 500 such that the sensitive element 230 of each remote module 20 measures a parameter inside of each battery 400, temperature or pressure for example.

### Example 4: Fuel Cell 600

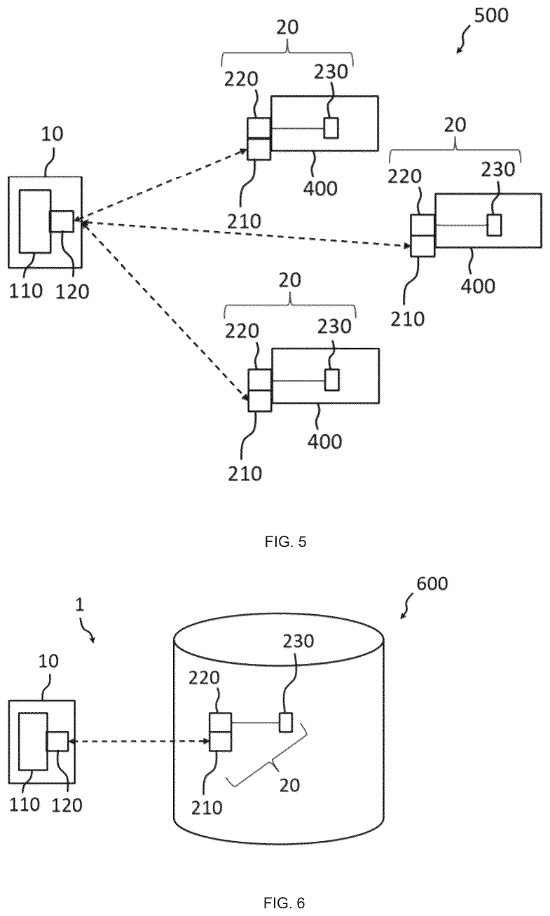

FIG. 6 is an example of a fuel cell 600 for a motor vehicle.

The main module 10 is placed away from the fuel cell 600 while the remote module 20 is mounted on the fuel cell 600 such that the sensitive element 230 measures a parameter inside said fuel cell 600, for example in the circuit for supplying air to the membranes of the fuel cell 600. Once again, the measured parameter(s) may for example be temperature, pressure, moisture content, electric current, mechanical force (stress) and/or torque.

### Example of Implementation

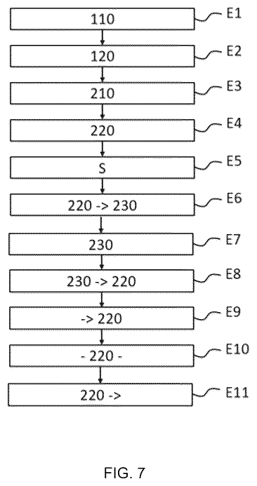

One example of implementation of the device 1 will now be described with reference to FIG. 7. In this non-limiting example, the parameter to be measured may for example be temperature, in particular inside a rotor 320 of an electric machine 300.

First of all, when the parameter has to be measured, the control stage 110 of the main module 10 commands, in a step E1, the piezoelectric transmitter 120 of the main module 10 to transmit ultrasonic signals.

The piezoelectric transmitter 110 of the main module 10 then transmits said ultrasonic signals in a step E2.

The piezoelectric receiver 210 of the remote module 20 receives the signals transmitted in a step E3 and then passes them to the measurement stage 220, which collects and stores the energy of the received signals in a step E4.

The measurement stage 220 stores the energy of the signals received until a predetermined threshold is reached in a step E5 and then electrically powers the sensitive element 230 using the energy stored in a step E6.

The sensitive element 230 then measures the parameter and generates a measurement signal S in a step E7, and then transmits said generated measurement signal S to the measurement stage 220 in a step E8.

The measurement stage 220 receives the generated measurement signal S in a step E9, and then extracts the one or more values of the measured parameter, for example the one or more temperature values, contained in the received measurement signal S in a step E10.

The measurement stage 220 then commands, in a step E11, transmission of signals comprising the extracted parameter values.

To do this, the measurement stage 220 may command the piezoelectric receiver 210, when the latter also performs the function of piezoelectric transmitter, in order to send the extracted parameter values in ultrasonic signals to the piezoelectric transmitter 120, which then also performs the function of piezoelectric receiver, and then the piezoelectric transceiver 120 passes the parameter values to the control stage, which may use them to control a system such as, for example, the speed of rotation or the position of the rotor 320 of an electric machine 300.

An aspect of the invention therefore makes it possible to measure a parameter with a remote module that is supplied with electrical power wirelessly, thus avoiding use of a replaceable battery, something that is particularly advantageous in the case of a rotor of an electric machine.

1. A device for measuring a parameter, for a motor vehicle, said device comprising a main module and a remote module said main module comprising a control stage and a piezoelectric transmitter that is configured to transmit ultrasonic signals, said control stage being configured to electrically power said piezoelectric transmitter and to command transmission of signals by said piezoelectric transmitter, said remote module comprising a piezoelectric receiver configured to receive ultrasonic signals transmitted by the piezoelectric transmitter, a sensitive element configured to measure said parameter and to generate a measurement signal(S) comprising at least one value of said parameter, and a measurement stage that is connected on the one hand to the piezoelectric receiver and on the other hand to said sensitive element, and that is configured to collect and store the energy of the signals received by the piezoelectric receiver with a view to electrically powering the sensitive element, to receiving a measurement signal (S) generated by the sensitive element, to extracting from said received measurement signal (S) the values of the measured parameter and to commanding transmission of signals comprising the extracted parameter values.

2. The device as claimed in claim 1, wherein the piezoelectric receiver of the remote module also being a piezoelectric transmitter and the piezoelectric transmitter of the main module also being a piezoelectric receiver, the measurement stage is configured to command transmission of signals containing the measured values via said piezoelectric transceiver of the remote module and the control stage of the main module is configured to receive the signals containing the measured values via said piezoelectric transceiver of the main module.

3. The device as claimed in claim 1, wherein, the remote module comprising an external communication stage, the measurement stage is configured to command transmission of signals containing the measured values via said external communication stage.

4. The device as claimed in claim 1, wherein the piezoelectric transmitter of the main module is configured to resonate at least at one predetermined frequency, the control stage is configured to generate a signal at said at least one predetermined frequency and to deliver the generated signal to the piezoelectric transmitter of the main module, and the piezoelectric receiver of the remote module is configured to resonate at said at least one predetermined frequency.

5. An electric machine for a motor vehicle, said electric machine comprising a stator, a rotor and a device as claimed in claim 1, said electric machine being configured to be mounted in said vehicle in order to drive the wheels of said vehicle to rotate, in which electric machine the main module is mounted on the stator and the remote module is mounted on the rotor.

6. The electric machine as claimed in claim 5, wherein, the rotor comprising a shaft comprising a first shaft portion and a second shaft portion that are mounted on the stator via a system of bearings, the first shaft portion having an end face extending orthogonally to the longitudinal axis of rotation of the rotor, the piezoelectric receiver of the remote module is mounted on said end face and the piezoelectric transmitter of the main module is mounted on a portion of the stator facing said piezoelectric receiver of the remote module.

7. A motor-vehicle battery pack comprising a measuring device as claimed in claim 1, the remote module being mounted such that the sensitive element is placed in at least one battery of the battery pack.

8. A motor vehicle comprising a measuring device as claimed in claim 1.

9. A method for measuring a parameter in a motor vehicle using a measuring device as claimed in claim 1, said method comprising:
commanding, by the control stage of the main module, transmission of ultrasonic signals by the piezoelectric transmitter of the main module,
transmitting, by the piezoelectric transmitter of the main module, said ultrasonic signals,
receiving, by the piezoelectric receiver of the remote module, the transmitted signals,
collecting and storing, by means of the measurement stage of the remote module, energy of the received signals,
electrically powering, by means of the measurement stage of the remote module, using the stored energy, the sensitive element of the remote module,
measuring, by the sensitive element, said parameter and generating a measurement signal,
transmitting, by the sensitive element, said generated measurement signal to the measurement stage,
receiving, by the measurement stage, the measurement signal,
extracting, by the measurement stage, the values of the measured parameter contained in the received measurement signal,
commanding, by the measurement stage, transmission of signals comprising the extracted parameter values.

10. The method as claimed claim 9, wherein the energy of the received signals is stored, by the measurement stage, until a predetermined threshold is reached, and then the sensitive element is electrically powered using the stored energy.
